(19) United States
(12) Patent Application Publication
(10) Pub. No.: US 2010/0237217 A1
(43) Pub. Date: Sep. 23, 2010

(54) FOLDING PORTFOLIO

(75) Inventor: Bjorn G. Sao, Stratford, CT (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Expand International AB

(21) Appl. No.: 12/729,588

(22) Filed: Mar. 23, 2010

Related U.S. Application Data
(60) Provisional application No. 61/210,754, filed on Mar. 23, 2009.

(51) Int. Cl. F16M 11/22

(52) U.S. Cl. 248/425; 248/440.1

(57) ABSTRACT

A portfolio including a base panel having a support surface on one side and a pair of support legs on an opposite side. The portfolio also has a lateral panel connected to the base panel and in contact with the support surface. The pair of support legs support the base panel and lateral panel at an incline on a flat surface. A portfolio that rests on a flat surface for displaying flat materials is provided. The portfolio has a base panel and a pair of support legs extending from back panel to permit the base panel to be inclined on the flat surface. The portfolio has a first lateral panel connected to one side of the base panel and a second lateral panel connected to an opposite side of the base panel from the first lateral panel. The first lateral panel and the second lateral panel are coplanar.

### CROSS-REFERENCE TO RELATED APPLICATION

This application claims the benefit of U.S. Provisional Application No. 61/210,754 filed on Mar. 23, 2009, which is incorporated by reference herein.

### BACKGROUND OF THE INVENTION

1. Field of the Invention

The present disclosure relates to a folding portfolio. More particularly, the present disclosure relates to a folding portfolio that can be used to present a display in a substantially vertical and/or flat orientation on a surface.

2. Description of Related Art

There exist numerous folding portfolios for sales persons and artists to carry for the display of graphic arts, advertising materials or art work at tradeshows or other such events. Such portfolios must be able to effectively display large presentations that are easily viewable from a distance in a large venue, but also from different angles in a smaller venue. Additionally, such portfolios must be able to be easily and securely carried by the salesperson or artist.

Accordingly, there is a need for a folding portfolio that permits a display secured to its surface to be viewed in a flat and substantially vertical orientation for easy viewing and subsequent transport.

### SUMMARY OF THE INVENTION

The present disclosure provides for a folding portfolio that has a base panel, two lateral panels and an upper panel disposed above the base panel in a deployed configuration that can also be folded over the base panel and secured for ease of transporting the portfolio.

The present disclosure also provides that the lateral panels be removable in the deployed configuration to permit a vertically oriented display to lie in a flat orientation against the base panel and the upper panel.

The present disclosure further provides for a folding portfolio having cooperative sliding members disposed on opposite sides of the base panel and the upper panel which members cooperate to ensure that the portfolio is securely locked to prevent accidental opening during transport.

The present disclosure still further provides for a folding portfolio having foldable support legs disposed at the back of the base panel to permit the base panel to tilt at a slight angle when the lateral panels and the upper panel are fully deployed for ease of viewing.

The present disclosure yet further provides for a folding portfolio having foldable support legs disposed at the back of the base panel that can be folded and secured within recesses molded in the back of the base panel when the portfolio is in not in use.

The present disclosure yet still further provides for a foldable portfolio having recesses for the thumb and forefingers in the base panel and the upper panels, when the portfolio is in a non-deployed configuration for ease of carrying.

The present disclosure further provides for a folding portfolio in which a display secured to lateral panels, a base panel and/or an upper panel can be folded inside of a non-deployed portfolio without damage to the display.

The present disclosure also provides for a portfolio having a base panel with raised hinge connection members on opposite sides that are supported on a hinge support surface. Raised hinge connection members interconnect with lateral panel pins, such that back surfaces of lateral panels are in contact with hinge support surface when portfolio is supported by support legs in a deployed configuration. Contact between back surface of lateral panels and hinge support surface of base panel permits lateral panels to lie in the same plane and to be parallel with the plane of base panel.

A portfolio that rests on a flat surface including a base panel having a support surface on one side and a pair of support legs on an opposite side. The portfolio also has a lateral panel connected to the base panel and in contact with the support surface. The pair of support legs support the base panel and lateral panel at an incline to the flat surface.

A portfolio that rests on a flat surface for displaying flat materials is provided. The portfolio has a base panel and a pair of support legs extending from back panel to permit the base panel to be inclined on the flat surface. The portfolio has a first lateral panel connected to one side of the base panel and a second lateral panel connected to an opposite side of the base panel from the first lateral panel. The first lateral panel and the second lateral panel are coplanar.

These and other and features and advantages will be apparent from the following detained description.

### BRIEF DESCRIPTION OF THE DRAWINGS

FIG. 1 illustrates a front perspective view of a folding portfolio in the non-deployed position, according to the present disclosure;

FIG. 2 illustrates a bottom perspective view of the folding portfolio according to FIG. 1;

FIG. 3 illustrates a front perspective view of the folding portfolio of FIG. 1 in the fully deployed position;

FIG. 4 illustrates a front view of the portfolio of FIG. 3;

FIG. 5 illustrates a partial front perspective view of the portfolio of FIG. 1, showing the installation of a lateral panel;

FIG. 6 illustrates a rear perspective view of the portfolio of FIG. 3 with the support legs in the fully deployed position;

FIG. 7 illustrates a side view of the portfolio of FIG. 3;

FIGS. 8a through 8c illustrate a detailed view of the hinge connecting base panel and upper panel, of the folding portfolio of FIG. 1;

FIGS. 9a and 9b illustrate a support leg of FIG. 2;

FIG. 10 shows a side view of the locking mechanism of the portfolio of FIG. 1; and

FIGS. 11a and 11b show components of the locking mechanism on base panel and upper panel, of the portfolio of FIG. 1.

### DETAILED DESCRIPTION OF THE INVENTION

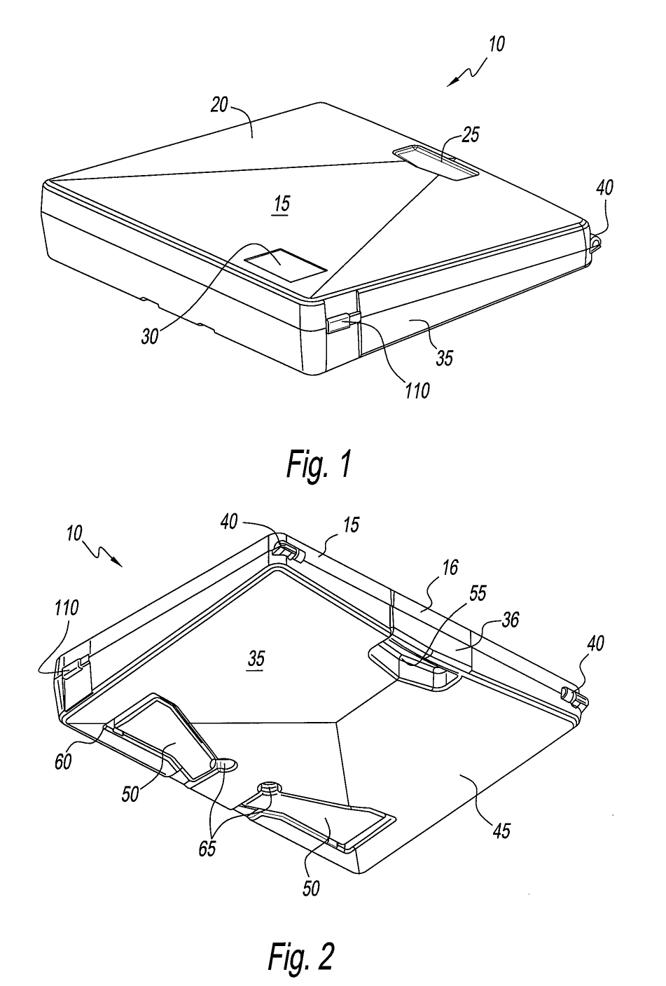

Referring to the figures and in particular to FIG. 1, the portfolio according to the present disclosure is shown generally and referenced using reference numeral 10. Portfolio 10 is shown in FIG. 1 in its closed and non-deployed configuration. Portfolio 10 has an upper panel 15 having an upper surface 20. Upper surface 20 has an upper recess 25 for receiving either the thumb or the forefingers of the user during transport. Additionally, upper surface 20 has a region 30 for affixing an identifier, for example a trademark. Portfolio 10 has a base panel 35 and a hinge 40 (one shown) that connects upper panel 15 and base panel 35 for relative pivoting movement therebetween.

Referring to FIG. 2, base panel 35 has a bottom surface 45. Base panel 35 has a pair of support legs 50 that are shown in a folded, non-deployed position for when portfolio 10 is being carried. Bottom surface 45 of base panel 35 has several recesses therein. Recess 55 is of a depth that is configured to permit a carrier's fingers or thumb to be inserted for carrying portfolio 10. Adjacent recesses 25 and 55 on upper panel 15 and base panel 35, respectively, are resting surface 16 and 36, to provide support surface between upper panel 15 and base panel 35 during deployment. Bottom surface 45 also has two recesses 60 that are configured to receive and retain support legs 50 during transport. Bottom surface 45 also has recesses 65 that are roughly circular in design to permit access and deployment of support legs 50. A user can insert a finger into recesses 65 and rotate support legs 50 away from bottom surface 35 to support portfolio 10 in the deployed position against a flat surface. Upper panel 15 and base panel 35 are locked using a locking mechanism 110 discussed further below.

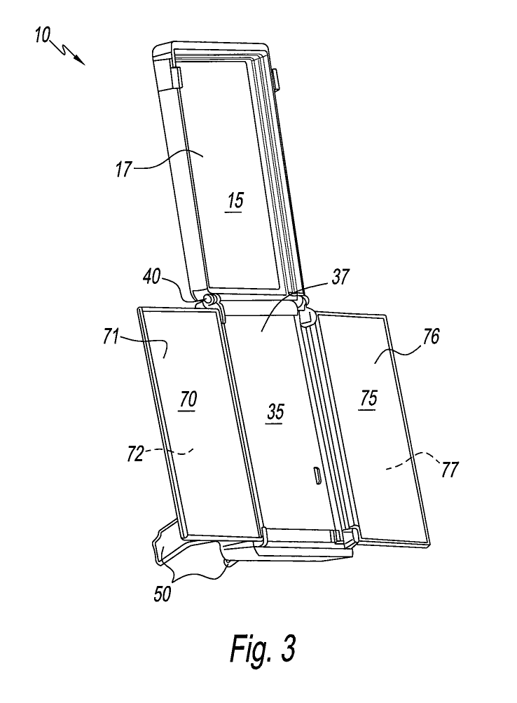

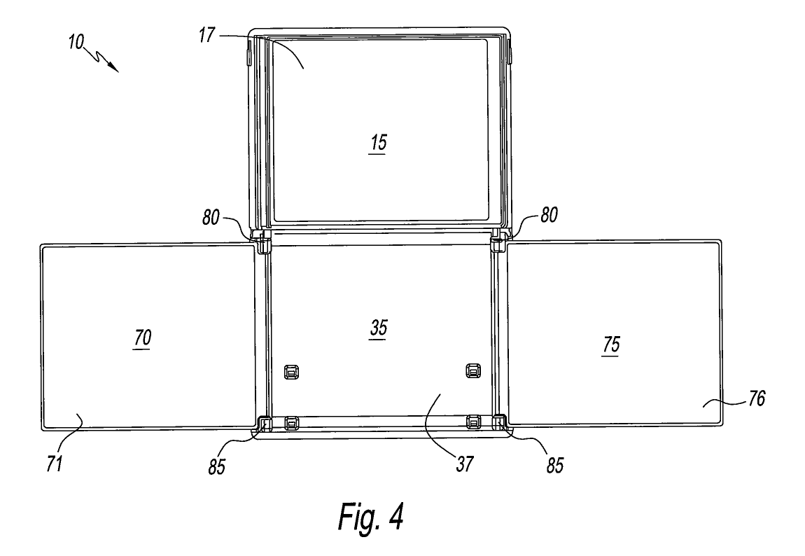

Referring to FIGS. 3 and 4, portfolio 10 is shown in its opened and fully deployed position and supported by legs 50. Portfolio 10 has two lateral panels 70 and 75, respectively. Lateral panels 70 and 75 are folded over base panel 35 when portfolio 10 is in a non-deployed configuration. Either lateral panel 70 or lateral panel 75 is a first lateral panel or a second lateral panel. Lateral panels 70 and 75 are each secured to base panel 20 at upper hinges 80 and lower hinges 85, respectively. To fully close folding portfolio 10, upper panel 15 is folded over lateral panels 70 and 75 and locked using locking mechanism 110.

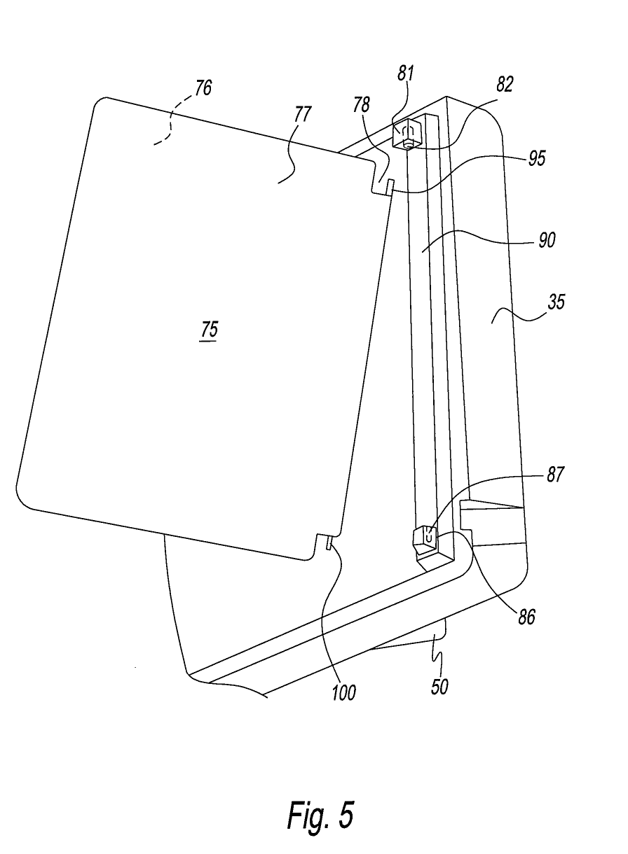

Referring to FIG. 4, upper panel 15 has a front surface 17 and base panel 35 has a front surface 37. Lateral panels 70 and 75 have a front surface 71 and 76 and a back surface 72 and 77, respectively. Surfaces 17, 37, 71 and 76 are each surfaces upon which an adhesion material, such as a material having one of a hook or an eye configuration, is affixed. A flat and flexible display having an opposing hook or an eye configuration is affixed to adhesion material of surfaces 17, 37, 71 an/or 76 for attachment to portfolio 10. There are numerous configurations for displaying materials in portfolio. All four panels can be used for a single large display, four individual displays, or a single vertical display using the configuration of FIGS. 3 and 5. Additionally, an entire display can be entirely folded and enclosed inside of portfolio 10 is a closed or non-deployed configuration without damaging display.

Referring to FIG. 5, a portion of base panel 35 is shown and includes details of hinges 80 and 85, respectively. Lateral panels 70 and 75 are each removably secured to base panel 35 at hinges 80 and 85 in the same fashion. Accordingly, the connection of panel 75 and base panel 35 will be shown and addressed with respect to FIG. 5, for purposes of simplicity. Base panel 35 has an upper hinge member 81 and a lower hinge member 86. Upper hinge member 81 and lower hinge member 86 each has a hole 82 and 87, respectively, therein. Upper hinge member 81 and lower hinge member 86 are each disposed on elevated hinge support 90 that spaces upper hinge member 81 and lower hinge member 86 from the main body of base panel 35. Lateral panel 75 has an upper pin 95 and a lower pin 100. Upper pin 95 and lower pin 100 are sized to fit into hole 82 and hole 87, respectively, each in a sliding and rotating relationship. Lateral panel 75 has spaces 78 between upper pin 95 and lower pin 100 to provide clearance between lateral panel 75 and upper hinge member 81 and lower hinge member 86 during installation and operation. A second hinge support (not shown) is provided on opposite side of base panel that is identical to and parallel to hinge support 90.

In operation, upper pin 95 is initially inserted into hole 82 and then lower pin 100 is placed into hole 87. Upper pin 95 is sized to be longer than lower pin 100 to eliminate the possibility of upper pin 95 from becoming disengaged from hole 82 when portfolio 10 is in use and supported by legs 50. The same process for installation is repeated for lateral panel 70.

Significantly, when portfolio 10 is in use, back side 77 of lateral panel 75 directly contacts hinge support 90 of base panel 35, to permit the configuration as shown in FIGS. 3 and 5. There is no angle between back side 77 and hinge support 90. By back side 77 and hinge support 90 being in contact, front side 72 of lateral panel 70 and front side 76 of lateral panel 75 are permitted to lie in the same plane. Alternatively stated, there is a 180° angle between lateral panel 70 and lateral panel 75. Furthermore, lateral panel 70 and lateral panel 75 are also parallel to the plane of surface 37 of base panel 35. A display is able to rest on surfaces 17, 37, 71 and 76 in a flat configuration when display 10 is deployed. In the deployed configuration, lateral panel 70, lateral panel 75, base panel 35 and upper panel 15 have an inverted T-shape.

Thus, upper hinges 80 and lower hinges 85 permit an interlocking relationship between lateral panels 70 and 75 and base panel 35 to allow engagement and disengagement therebetween to permit the vertical configuration as shown in FIGS. 3 and 5. In this way, panels 70 and 75 can be either engaged or disengaged.

Referring to FIG. 7, upper panel 15 is shown when portfolio 10 is in the deployed position. As shown in FIGS. 8a, 8b and 8c, upper panel 15 moves relative to base panel 35 via hinges 40. Hinges 40 include relative moving components of upper panel 15 and base panel 35. Upper panel 15 has a corner 41 that rotates around curved hinge surface 44 of base panel 35. As upper panel 15 is moved to the deployed configuration, resistance and friction are cause as corner 41 and curved hinge surface 44 come into contact during relative movement. The friction between corner 41 and curved hinge surface 44, prevents upper panel 15 from inadvertently closing during use. When a user opens portfolio and rotates upper panel 15 away from base panel 35, a slight resistance is felt due to the resistance and friction between the relatively moving components, namely corner 41 and curved hinge surface 44. The resistance indicates to the user that upper panel 15 is proximate its fully deployed position.

Further, when portfolio 10 is in the deployed position, hinges 40 permit full rotation of upper panel 15 relative to base panel 35 so that resting surfaces 16 and 36 of upper panel 15 and base panel 35 are in contact. There is full clearance between upper panel 15 and base panel 35. Resting surfaces 16 and 36 and hinges 40 ensure that the angle between upper panel 15 and base panel is less than 180° but greater than 175°, as shown in FIG. 7. Were the angle between base panel 35 and upper panel 180° or greater, portfolio 10 would be unstable and viewing of display may be compromised. Further base panel 35 is of a depth and width that provides stability to portfolio during deployment.

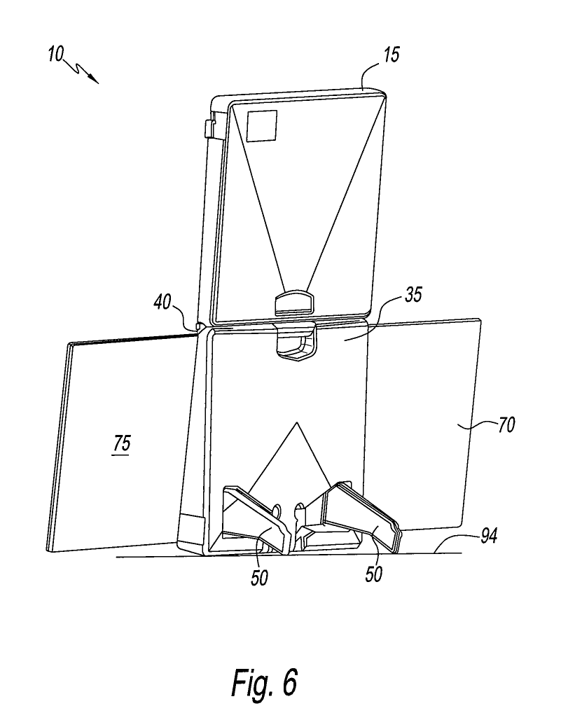

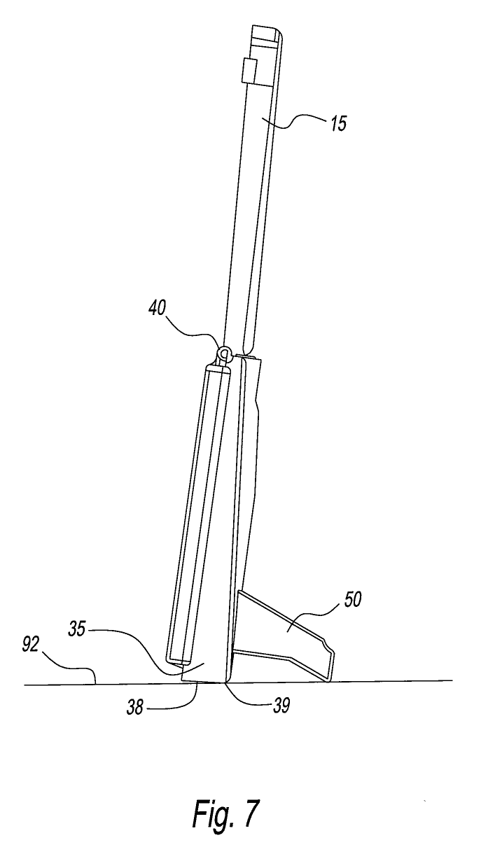

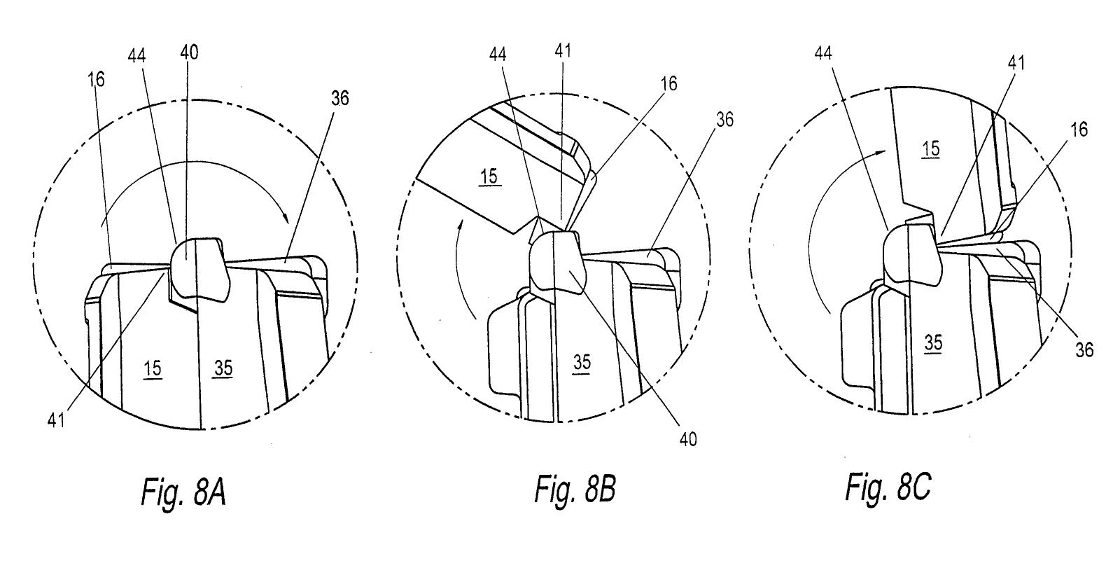

Referring to FIGS. 6 and 7, legs 50 support the entire weight of portfolio in a slightly inclined position. Base panel has a lower edge 38 that rests on support surface, such as a table 90. The entire lower edge 38 of base panel 35 is not in contact with support surface 90 during use. Only the back edge 39 of base panel 35 contacts the surface 90. Significantly, by base panel 35 being slightly inclined, lateral panels 70 and 75 are able rest against hinge support surface 90 and achieve contact therebetween and lie in the same plane for easy viewing of a display thereon. Lateral panels 70 and 75 are not needed for support of portfolio in a deployed position, by for example, resting on a surface at an angle relative to base panel 35. Were portfolio only supported by lower edge 38, base panel 35 would not be stable and upper panel 15 close due to its weight.

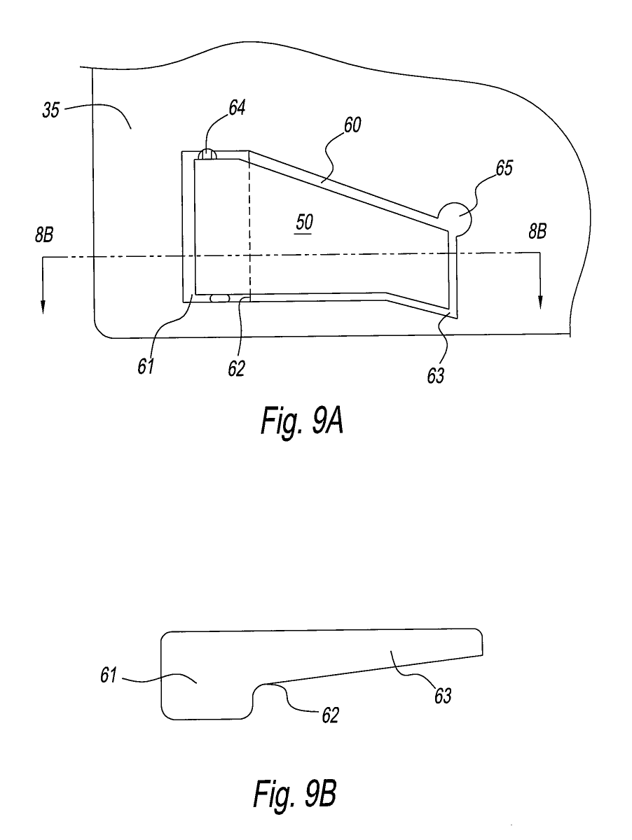

Referring to FIGS. 2, 6, 9a and 9b, legs 50 of the present invention are shown. Legs 50 can either be in a non-deployed configuration as shown in FIGS. 2 and 9a or in a deployed configuration as shown in FIG. 6. In the non-deployed configuration, legs 50 are each disposed in recess 60. Legs 50 each contain a pin 64 to permit rotation within a reciprocal member of base panel 35. Legs 50 are rotated away from surface 45 to obtain the deployed configuration when portfolio 10 is in use. As shown in FIG. 9b, a cross-section shows that recess 60 has a variable depth. Recess 60 has a deep portion 61, a shallow portion 63 and in inflection region 62 that is a sharp transition between deep portion 61 and shallow portion 63. Inflection region 62 is abutted when leg 50 is rotated for deployment and thus provides friction between recess 60 and leg 50. The friction caused by inflection region 62 ensures that legs 50 remain in a deployed configuration during portfolio use. Further, inflection region 62 ensures that legs 50 remain in a non-deployed configuration during portfolio storage or transport.

Recesses 60 are proximate recesses 65 on surface 45. Recesses 65 are roughly circular in design to permit access to and deployment of support legs 50. A user of portfolio 10 can insert a finger into recess 65 and rotate support legs 50 away from base panel 35 to support portfolio 10 in the deployed position against a flat surface.

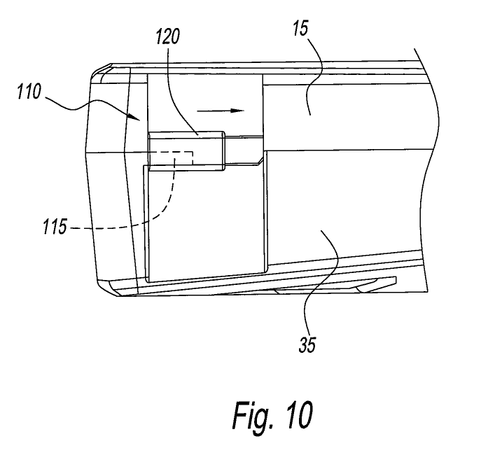

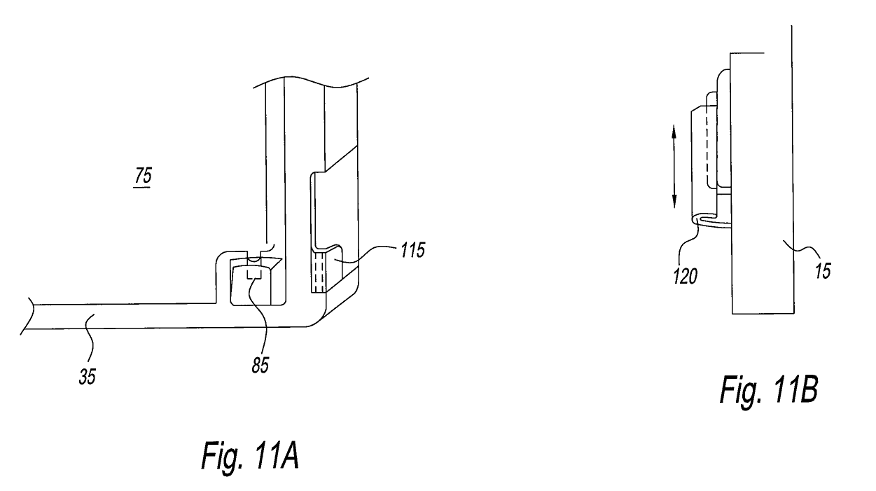

Referring to FIGS. 10, 11a and 11b, a locking mechanism 110 is shown. Locking mechanism 110 has two reciprocally operating members 115 and 120. Catch 115 is disposed on base panel 35. Opposing sliding member 120, is disposed on upper panel 15. In the non-deployed configuration of FIG. 9, sliding member 120 is disposed over or engages catch 115 and prevents relative pivotal movement between upper panel 15 and base panel 35. Significantly, when portfolio 10 is being carried, sliding member 120 is at its lowest most point covering catch 115 to prevent inadvertent opening. When a user deploys or unfolds portfolio 10, sliding member 120 is moved in a direction to uncover or disengage catch 115 of base panel 35. By moving member 120 as shown by arrow of FIG. 10, catch 115 is released and relative movement between upper panel 15 and base panel 35 is permitted. When sliding member 120 engages and disengages catch 115, friction between inner surface of sliding member 120 and outer surface of catch 115 causes resistance and an audible indication of a locked state or alternatively, opened state. The audible and tactile indication of closure provides two safety features to the user to ensure that inadvertent opening or locking do not occur. Locking mechanism 110 is preferably disposed on each side of portfolio 10.

Portfolio 10 is preferably made from high density polyethylene, although other materials could also be used to form lateral panels 70 and 75 and base panel 35 and upper panel 15. Portfolio 10 is preferably made by in an injection molding process, commonly known in the art.

The present disclosure has been described with particular reference to the preferred embodiment. It should be understood that the foregoing descriptions and examples are only illustrative of the present disclosure. Various alternatives and modifications thereof can be devised by those skilled in the art without departing from the spirit and scope of the present disclosure. Accordingly, the present invention is intended to embrace all such alternatives, modifications, and variations that fall within the scope of the present disclosure.

I claim:

1. A portfolio that rests on a flat surface comprising:
a base panel having a support surface on one side and a pair of support legs on an opposite side; and
a lateral panel connected to said base panel and in contact with said support surface;
wherein said pair of support legs support said base panel and said lateral panel on the flat surface at an incline to the flat surface.

2. The portfolio according to claim 1, further comprising an angle of 0° that exists between said lateral panel and said support surface.

3. The portfolio according to claim 1, further comprising a second support surface disposed on a side of said base panel opposite said pair of support legs, and a second lateral support panel on an opposite side of said base panel from said lateral support panel and connected to said base panel and in contact with said second support surface.

4. The portfolio according to claim 3, wherein said lateral panel is a first lateral panel and said support surface is a first support surface, and wherein said first lateral panel and said second lateral panel each has a front side and a back side, and 0° angles exists between said back side of said first lateral panel and said first support surface and between said back side of said second lateral panel and said second support surface.

5. The portfolio according to claim 4, said base panel further comprising a pair of recesses on said first support surface and a pair of recesses on said second support surface.

6. The portfolio according to claim 4, wherein said front side of said first lateral panel and said front side of said second lateral panel are co-planar.

7. The portfolio according to claim 5, wherein said first lateral panel and said second lateral panel each has a first pin and a second pin on one side thereof, said first pin and said second pin of said first lateral panel being slidingly received in said pair of recesses on said first support surface and said first pin and said second pin of said second lateral panel being slidingly received in said pair of recesses on said second support surface and said second surface.

8. The portfolio according to claim 7, wherein said first lateral panel and said second lateral panel are rotatable in said pair of recesses to lie on opposite sides of said base panel in a coplanar configuration.

9. The portfolio according to claim 7, wherein said first lateral panel and said second lateral panel are rotatable in said pair of recess to fold over said base panel in a non-deployed configuration such that there exists an angle of 0° between said first support panel and said second support panel.

10. The portfolio according to claim 3, further comprising an upper panel connected to said base panel, wherein said upper panel, said base panel, said first lateral panel and said second lateral panel form an inverted T-shape in a deployed configuration.

11. The portfolio according to claim 10, further comprising a hinge disposed between said upper panel and said lower panel that permits rotation between said upper panel and said lower panel such that said upper panel and said lower panel are permitted to have an angle of 0° therebetween in a closed configuration and an angle of from 175° to 180° therebetween in a deployed configuration.

12. The portfolio according to claim 11, wherein said upper panel, said base panel, said first lateral panel and said second lateral panel have a deployed configuration in which said first panel said second lateral panel are co-planar and said upper panel and said base panel have an angle of 175° to 180° therebetween and a non-deployed configuration in which said first lateral panel and said second lateral panel are between said upper panel and said base panel.

13. The portfolio according to claim 10, further comprising a contact adhesion surface affixed to said base panel, said upper panel, said first lateral panel and said second lateral panel for attachment of a display material.

14. The portfolio according to claim 10, wherein said base panel comprises at least one latch and said upper panel comprises slidable member that moves over said at least one latch to lock said base panel and said upper panel in a closed/non-deployed configuration.

15. A portfolio that rests on a flat surface for displaying flat materials comprising:
a base panel;
pair of support legs extending from said back panel to permit said base panel to be inclined on the flat surface; and
a first lateral panel connected to one side of said base panel and a second lateral panel connected to an opposite side of said base panel from said first lateral panel;
wherein said first lateral panel and said second lateral panel are coplanar.

16. The portfolio according to claim 15, further comprising an upper panel connected to said base panel, wherein said base panel is between the upper panel and the flat surface.

17. The portfolio according to claim 16, wherein said upper panel, said base panel, said first lateral panel and said second lateral panel form an inverted T-shape in a deployed configuration.

18. The portfolio according to claim 16, further comprising a hinge disposed between said upper panel and said lower panel that permits rotation between said upper panel and said lower panel such that said upper panel and said lower panel are permitted to have an angle of 0° therebetween in a closed configuration and an angle of from 175° to 180° therebetween in a deployed configuration.

19. The portfolio according to claim 15, wherein said base panel further comprises a first support surface and a second support surface on a front side opposite a back side from which said pair of support legs extends.

20. The portfolio according to claim 15, wherein one of said support surfaces is a first support surface and the other of said support surfaces is a second support surface and said first lateral panel is releasably connected to said first support surface and said second lateral panel is releasably connected to said second support surface.

21. The portfolio according to claim 20, wherein an angle between said first support surface and said first lateral panel is 0° and an angle between said second support surface and said second lateral panel is 0°.

22. The portfolio according to claim 19, wherein said first support surface and said second support surface are parallel.

23. The portfolio according to claim 17, wherein said upper panel, said base panel, said first lateral panel and said second lateral panel each has a contact surface to which the display can adhere.

24. The portfolio according to claim 17 wherein said portfolio has a non-deployed configuration in which said first lateral panel and said second lateral panel are covering said base panel and said upper panel rotates to cover said base panel such that said first lateral panel and said second lateral panel are enclosed between said base panel and said upper panel.

25. The portfolio according to claim 15, wherein said first lateral panel, said second lateral panel and said base panel are inclined at the same angle relative to the flat surface.
